(19) United States
(12) Patent Application Publication
(10) Pub. No.: US 2026/0281730 A1
(43) Pub. Date: Sep. 17, 2026

(54) ALLOCATING RESOURCES IN A CELL

(71) Applicant: Telefonaktiebolaget LM Ericsson (publ), Stockholm (SE)

(72) Inventor: Patrick MAGUIRE, Athlone (IE)

(21) Appl. No.: 19/162,545

(22) PCT Filed: Mar. 6, 2023
(86) PCT No.: PCT/EP2023/055624

§ 371 Date: Sep. 5, 2025

(51) Int. Cl. H04W 16/10; H04W 72/566; H04W 88/10

(52) U.S. Cl. CPC H04W 16/10; H04W 72/566; H04W 88/10

(57) ABSTRACT

Methods and apparatus are provided. In some examples, a method of allocating resources in a cell is provided. A first proportion of resources in the cell are allocated to a first radio access technology (RAT) and a second proportion of the resources in the cell are allocated to a second RAT different to the first RAT, and the cell supports resource partitioning of resources of the first RAT for one or more groups of one or more networks, network slices or User Equipments (UEs). The method comprises determining, for individual groups, one or more respective proportions of the resources for the group based on the resource partitioning, and determining, for individual groups, one or more adjusted proportions of the 0 resources based on the one or more proportions of the resources for the group and the first proportion of the resources of the cell allocated to the first RAT. The method also comprises allocating the resources of the cell based on the one or more adjusted proportions of the resources of the cell for individual groups.

### TECHNICAL FIELD

Example embodiments of this disclosure relate to allocating resources in a cell, for example wherein the cell supports spectrum sharing and resource partitioning.

### BACKGROUND

Cells in a wireless communication system such as a 3rd Generation Partnership Project (3GPP) wireless communication system, may support spectrum sharing. Spectrum sharing is the capability to dynamically share spectrum between radio access technologies (RATs) on the same band, i.e. in the same cell. For example, the spectrum may be shared between Long Term Evolution (LTE) and New Radio (NR) technologies.

As an example, Ericsson Spectrum Sharing (ESS) is an inter-RAT solution consisting of specific features. It enables the introduction of NR in existing LTE infrastructure due to the use of intelligent scheduler algorithms and smart coordination of NR and LTE signaling. With ESS, spectrum may be dynamically shared between the LTE and NR technologies on the same band.

ESS enables the introduction of NR in a spectrum used by LTE Frequency Division Duplexing (FDD). Instead of having to assign different resources manually to LTE and NR at a fixed ratio, ESS can assign resources dynamically based on traffic load, with the intention of boosting performance and end-user experience in any location. With an existing LTE FDD radio spectrum, it is possible to introduce continuous 5G coverage and decrease mid-band resource consumption, with fewer new sites, in a time- and cost-efficient way [1].

In ESS, NR users compete against LTE users for spectrum resources. LTE users are the dominant traffic in current networks. Because of this, the scheduling opportunity for NR users is reduced.

However, to address this potential unfair usage of shared resources, the LTE-NR FDD Spectrum Sharing with Policy-based Biasing feature was introduced which prioritizes non-guaranteed bit rate (non-GBR) traffic between LTE and NR based on operator configuration. This feature provides an option to prioritize non-GBR traffic of one RAT over the other in spectrum sharing configuration. The non-GBR prioritization is implemented in the time domain when traffic demand exists. If the prioritized RAT does not need all of the resources, the remaining resources can be assigned to the non-prioritized RAT. The feature makes it possible to prioritize NR best effort traffic to overcome the competition against LTE best effort traffic. In some cases, it might be desirable to instead prioritize LTE best effort traffic over NR best effort traffic, instead of treating them fairly, such as for example during NR trials.

The feature uses the SharingGroup. schedPolicy parameter that enables favouring LTE non-GBR traffic by setting it to LTE_BIASED. In this case, when only NR and LTE non-GBR traffic is present, more slots are used for LTE non-GBR traffic. In particular, when the SharingGroup. schedPolicy parameter is set to LTE_BIASED, the ratio between the number of transmission time intervals (TTIs) in which LTE non-GBR is prioritized over NR non-GBR is 2:1 in downlink, and 3:1 in uplink. In a TTI, when there is no demand from either RAT, 75% resources are given to LTE and 25% resources are given to NR.

The SharingGroup.schedPolicy parameter also enables the function of favouring NR non-GBR traffic by setting it to NR_BIASED. In this case, when only NR and LTE non-GBR traffic is present, more slots are used for NR non-GBR traffic. In particular, when the SharingGroup.schedPolicy parameter is set to NR_BIASED, the ratio between the number of TTIs in which NR non-GBR is prioritized over LTE non-GBR is about 3:1 both in downlink and uplink. In a TTI, when there is no demand from either RAT, 75% resources are given to NR and 25% resources are given to LTE.

When the SharingGroup.schedPolicy parameter is set to the default FAIR, the RATs are handled with equal priority. In a TTI, when there is no demand from either RAT, 50% resources are given to each RAT.

For any configuration of SharingGroup.schedPolicy, if there is no demand from LTE in uplink, all uplink resources are given to NR.

Radio Resource Partitioning is the capability in New Radio (NR) to configure a percentage of NR radio spectrum for a specific group in the UL/DL directions, or both, in a given cell. Groups of user plane traffic can be configured with a cell specific share of downlink and uplink spectrum resources (a “partition”) to which the traffic within the group has prioritized access. The traffic can be defined via combinations of Public Land Mobile Network ID (PLMN ID), Single-Network Slice Selection Assistance Information (S-NSSAI), and 5G Quality of Service Identifier (5QI).

Partitions are defined as a percentage of the total cell spectrum resources (a “share”) for an associated group of traffic. The share of the resources is prioritized for use by the associated traffic when it needs to use them. When not used, these free resources may be used by other traffic, if the partition is not permanently allocated to the group. Partitions can be configured independently in different cells. Traffic not associated with any share of spectrum resources can only use free resource not needed by the partitions.

In 3GPP [2], a Resource Partition is defined using the RRMPolicyRatio class. Apart from inherited attributes (DN, resource Type, rRMPolicyMemberList), RRMPolicyRatio has three attributes, illustrated in FIG. 1:
The attribute rRMPolicyMaxRatio defines the maximum resource usage quota for the associated group (rRMPolicyMemberList), including at least one of shared resources 100, prioritized resources 102 and dedicated resources 104. The sum of the ‘rRMPolicyMaxRatio’ values assigned to all RRMPolicyRatio(s) name-contained by same MangedEntity can be greater than 100% of the total resources 106 allocated to NR.
The attribute rRMPolicyMinRatio defines the minimum resource usage quota for the associated RRMPolicyMemberList, including at least one of prioritized resources 102 and dedicated resources 104, which means the resources quota that need to be guaranteed for use by the associated rRMPolicyMemberList. The sum of the ‘rRMPolicyMinRatio’ values assigned to all RRMPolicyRatio(s) name-contained by same MangedEntity shall be less or equal 100% of the total resources 106 allocated to NR.
The attribute rRMPolicyDedicatedRatio defines the dedicated resource usage quota for the RRMPolicyMemberList, including dedicated resources 106. The sum of the ‘rRMPolicyDedicatedRatio’ values assigned to all RRMPolicyRatio(s) name-contained by same MangedEntity shall be less or equal 100% of the total resources 106 allocated to NR.

The following are the definitions for above mentioned three resource categories:
Shared resources: these resources are shared with other groups (rRMPolicyMemberList(s)), i.e. the rRMPolicyMemberList(s) defined in RRMPolicyRatio(s) name-contained by the same ManagedEntity. The shared resources are not guaranteed for use by the associated rRMPolicyMemberList. The shared resources quota is represented by [rRMPolicyMaxRatio-rRMPolicyMinRatio].
Priortized resources: these resources are preferentially used by the associated RRMPolicyMemberList. These resources are guaranteed for use by the associated RRMPolicyMemberList when it needs to use them. When not used, these resources may be used by other rRMPolicyMemberList(s) (i.e. the rRMPolicyMemberList(s) defined in RRMPolicyRatio(s) name-contained by the same ManagedEntity). The prioritized resources quota is represented by [rRMPolicyMinRatio-rRMPolicyDedicatedRatio]
Dedicated resources: means the resources are dedicated for use by the associated RRMPolicyMemberList. These resources can not be shared even if the associated RRMPolicyMember does not use them. The Dedicated resources quota is represented by [rRMPolicyDedicatedRatio].

The allocation of a percentage of NR radio resources in a cell assumes that 100% of the cell resources are allocated to NR radio technology.

### SUMMARY

Examples of this disclosure may have certain advantages. For example, resource partitions may be configured based on available NR resources in all cells, including spectrum sharing cells. The configuration of NR resource partitions may in some examples automatically optimized over time based on resource partition usage and available NR spectrum resources on a per cell basis.

One aspect of the present disclosure provides a method of allocating resources in a cell. A first proportion of resources in the cell are allocated to a first radio access technology (RAT) and a second proportion of the resources in the cell are allocated to a second RAT different to the first RAT, and the cell supports resource partitioning of resources of the first RAT for one or more groups of one or more networks, network slices or User Equipments (UEs). The method comprises determining, for individual groups, one or more respective proportions of the resources for the group based on the resource partitioning, and determining, for individual groups, one or more adjusted proportions of the resources based on the determined one or more respective proportions of the resources for the group and the first proportion of the resources of the cell allocated to the first RAT. The method also comprises allocating the resources of the cell based on the one or more adjusted proportions of the resources of the cell for individual groups.

Another aspect of the present disclosure provides apparatus for allocating resources in a cell. A first proportion of resources in the cell are allocated to a first radio access technology (RAT) and a second proportion of the resources in the cell are allocated to a second RAT different to the first RAT, and the cell supports resource partitioning of resources of the first RAT for one or more groups of one or more networks, network slices or User Equipments (UEs). The apparatus comprises a processor and a memory. The memory contains instructions executable by the processor such that the apparatus is operable to determine, for individual groups, one or more respective proportions of the resources for the group based on the resource partitioning, determine, for individual groups, one or more adjusted proportions of the resources based on the determined one or more respective proportions of the resources for the group and the first proportion of the resources of the cell allocated to the first RAT, and allocate the resources of the cell based on the one or more adjusted proportions of the resources of the cell for individual groups.

An additional aspect of the present disclosure provides apparatus for allocating resources in a cell. A first proportion of resources in the cell are allocated to a first radio access technology (RAT) and a second proportion of the resources in the cell are allocated to a second RAT different to the first RAT, and the cell supports resource partitioning of resources of the first RAT for one or more groups of one or more networks, network slices or User Equipments (UEs). The apparatus is configured to determine, for individual groups, one or more respective proportions of the resources for the group based on the resource partitioning, determine, for individual groups, one or more adjusted proportions of the resources based on the determined one or more respective proportions of the resources for the group and the first proportion of the resources of the cell allocated to the first RAT, and allocate the resources of the cell based on the one or more adjusted proportions of the resources of the cell for individual groups.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates an example of attributes of a Resource Partition;

FIG. 2 is a flow chart of an example of a method of allocating resources in a cell; and

FIG. 3 is a schematic of an example of an apparatus 300 for allocating resources in a cell.

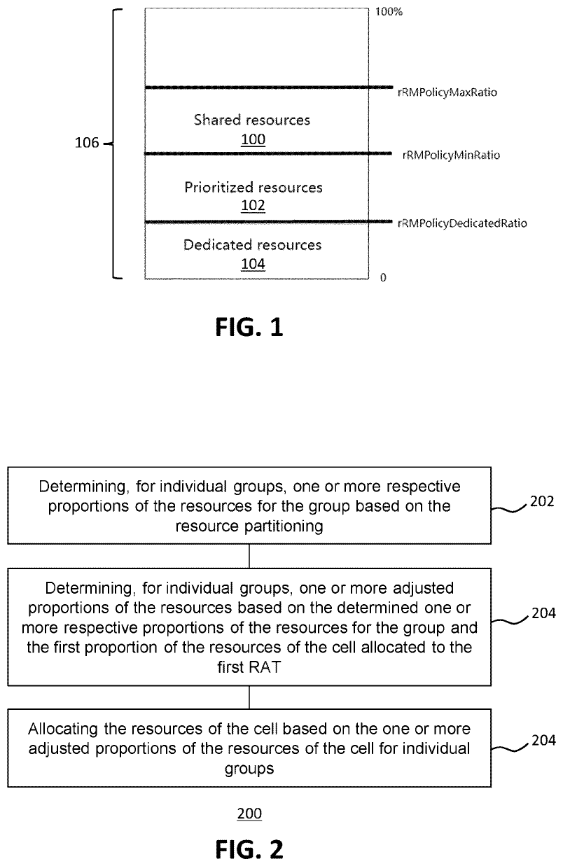

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

The problem with existing solutions is that the relationship between Spectrum Sharing and NR Radio Resource Partitioning and a cell, where one of the technologies sharing the spectrum in the cell is NR, is not specified. Without coordination, one resource sharing capability will interfere with the other with unknown implications, particularly for Protocol Data Unit (PDU) sessions in partitions using shared and prioritized resources.

Examples of this disclosure provide methods and apparatus that enable resource partitions for one RAT (e.g. NR) to be configured based on available NR resources in all cells, including spectrum sharing cells, where the spectrum is shared with a different RAT, e.g. LTE. In some examples, the configuration of resource partitions may be automatically optimized over time based on resource partition usage and spectrum available to the first RAT on a per cell basis. This may for example allow critical services supported by the network which are associated with resource partitions with configured Dedicated Resources to have their Service Level Agreement (SLA) guaranteed.

FIG. 2 is a flow chart of an example of a method 200 of allocating resources in a cell. A first proportion of resources (e.g. spectrum resources) in the cell are allocated to a first radio access technology (RAT), such as NR, and a second proportion of the resources in the cell are allocated to a second RAT different to the first RAT, such as LTE. The cell supports resource partitioning of resources of the first RAT for one or more groups of one or more networks, network slices or User Equipments (UEs).

The method 200 comprises, in step 202, determining, for individual groups (e.g. each group), one or more respective proportions of the resources for the group based on the resource partitioning. The one or more groups of one or more networks, network slices or User Equipments (UEs) may comprise for example one or more groups of Public Land Mobile Network Identifiers (PLMN IDs) and/or Single-Network Slice Selection Assistance Information (S-NSSAIs). Step 204 of the method 200 comprises determining, for individual groups (e.g. each group), one or more adjusted proportions of the resources based on the determined one or more respective proportions of the resources for the group and the first proportion of the resources of the cell allocated to the first RAT. That is, for example, for each group, an adjusted proportion of the resources may be determined for the group based on the proportion of the resources for the group (specified by the resource partitioning) determined in step 202.

The method 200 also comprises, in step 206, allocating the resources of the cell based on the one or more adjusted proportions of the resources of the cell for individual groups. This may comprise for example allocating one or more subcarriers, frequencies, time slots, transmission time intervals (TTIs), resource elements (REs), resource blocks (RBs) and/or frames based on the one or more adjusted proportions of the resources of the cell for individual groups.

Thus, the method 200 may for example enable allocation of resources according to resource partitioning, even in cells that support spectrum sharing between different RATs. In some examples, at least the step 204 of allocating the resources of the cell based on the one or more adjusted proportions of the resources of the cell for individual groups is performed by a resource scheduler. In some examples, the resource scheduler may perform one or more additional steps of the method 200, such as for example all steps of the method 200.

In some examples, the resource partitioning in the cell may specify, for each group, dedicated resources, prioritized resources and/or shared resources. Thus, for example, determining, for individual groups, the one or more respective proportions of the resources for the group based on the resource partitioning in step 202 comprises, for individual groups (e.g. each group): determining a proportion of the resources to be dedicated to the group by the resource partitioning; determining a proportion of the resources to be prioritized for the group by the resource partitioning; and/or determining a proportion of the resources to be shared by the group by the resource partitioning. It should be noted that different types of resources could be specified for different groups in some examples; for example, one group may have dedicated resources and shared resources, another group may just have dedicated resources, another group may have prioritized resources and shared resources, etc.

As a result, determining, for individual groups, one or more adjusted proportions of the resources in step 204 of the method may comprise, for individual groups (e.g. each group): determining an adjusted proportion of the resources of the cell to be dedicated to the group based on the proportion of the resources to be dedicated to the group and the first proportion of the resources of the cell allocated to the first RAT; determining an adjusted proportion of the resources of the cell to be prioritized for the group based on the proportion of the resources to be prioritized for the group and the first proportion of the resources of the cell allocated to the first RAT; and/or determining an adjusted proportion of the resources of the cell to be shared by the group based on the proportion of the resources to be shared by the group and the first proportion of the resources of the cell allocated to the first RAT. Allocating the resources of the cell based on the one or more adjusted proportions of the resources of the cell for individual groups in step 206 of the method 200 may thus in some examples comprise allocating the resources of the cell based on, the adjusted proportion of the resources of the cell to be dedicated to the group, the adjusted proportion of the resources of the cell to be prioritized for the group, and/or the adjusted proportion of the resources of the cell to be shared by the group.

In some examples, there may constraints on the adjusted proportions of the resources. For example, determining, for individual groups, one or more adjusted proportions of the resources in step 204 may comprise, for individual groups (e.g. each group), determining one or more adjusted proportions of the resources for the group such that a total of at least the adjusted proportion of the resources to be dedicated to the group and the adjusted proportion of the resources to be prioritized for the group does not exceed the first proportion of the resources in the cell.

Additionally or alternatively, for example, determining, for individual groups, one or more adjusted proportions of the resources in step 204 may comprise, for individual groups (e.g. each group), determining one or more adjusted proportions of the resources for the group such that each adjusted proportion does not exceed the first proportion of the resources in the cell.

In some examples of the method 200, allocating the resources of the cell based on the one or more adjusted proportions of the resources of the cell for individual groups comprises allocating one or more subcarriers, frequencies, time slots, transmission time intervals (TTIs), resource elements (REs), resource blocks (RBs) and/or frames based on the one or more adjusted proportions of the resources of the cell for individual groups.

In some examples, the method is performed in response to a change of the first proportion of the resources in the cell allocated to the first RAT and/or a change of the second proportion of the resources in the cell allocated to the second RAT. For example, if the first proportion changes so that fewer resources are allocated to the first RAT, then the adjusted portions of the resources may be adjusted again or recalculated such that they are smaller, or vice versa.

The resource partitioning may in some case specify resource partitions individually for uplink and downlink. This, for example, the first proportion of resources in the cell allocated to the first RAT may in some examples comprise a first uplink proportion of uplink resources and a first downlink proportion of downlink resources. Therefore, in some examples, determining, for individual groups, one or more adjusted proportions of the resources of the cell in step 204 of the method 200 may comprise: determining one or more adjusted proportions of the uplink resources of the cell based on the one or more proportions of the resources for the group and the first uplink proportion of the uplink resources of the cell allocated to the first RAT; and/or determining one or more adjusted proportions of the downlink resources of the cell based on the one or more proportions of the resources for the group and the first downlink proportion of the downlink resources of the cell allocated to the first RAT. Allocating the resources of the cell in step 206 may comprise for example allocating the uplink resources of the cell based on the one or more adjusted proportions of the uplink resources of the cell for individual groups, and/or allocating the downlink resources of the cell based on the one or more adjusted proportions of the downlink resources of the cell for individual groups. The second proportion of resources in the cell allocated to the second RAT may also in some examples comprise a second uplink proportion of uplink resources and a second downlink proportion of downlink resources.

In some examples, a network may continuously evaluate the cell load of supported technologies in a spectrum sharing cell (or all cells in the network), for example using available performance management (PM) data from the network, and reconfigure the resource allocation to each technology accordingly. This may be done for example by the cells themselves or by another node in the network.

In some examples, a network that includes one or more cells that support both spectrum sharing and resource partitioning may include a node, referred to as a NR Resource Allocation Configurator, that is responsible for determining the initial NR resource allocation policy for each resource partition in a cell in UL and/or DL direction. If the cell is a shared spectrum cell, it will also take into consideration the current resource allocation in UL and/or DL direction per technology in that cell. The NR Resource Allocation Configurator may optimize the NR resource allocation policy for each resource partition in a cell during runtime in UL &/ DL direction, taking into consideration the current resource allocation per technology in that cell (for spectrum sharing cells, this is likely to be less than 100%), and resource partition PM data reflecting the resource usage within the resource partitions. The NR Resource Allocation Configurator may in some examples perform the method 200 described above.

One or more of the following constraints may apply in some examples, but the applied constraints may be policy driven, which can be configured by a network operator. The configuration of any resource partition in UL &/ DL direction in some examples should not exceed the percentage of NR radio resources available in the cell (for spectrum sharing cells, this is likely to be less than 100%). The cumulative sum of all resource partition allocations in UL and/or DL direction of Dedicated Resources plus Prioritized Resources should not exceed the percentage of NR radio resources available in the cell (for spectrum sharing cells, this is likely to be less than 100%).

For spectrum sharing cells, in the event that during runtime the NR resource allocation is reduced, and the cumulative sum of all resource partition allocations of Dedicated Resources plus Prioritized Resources exceeds the new NR resource allocation, all resource partition resource allocations may be evaluated as follows. Assuming there are resource partitions with Dedicated Resources and Prioritized Resources, the following steps may be performed, for example by the NR Resource Allocation Configurator:
1. Determine the percentage overall reduction in resource usage required.
2. For any resource partitions with configured Dedicated Resources, if the resource utilization within the partition over time indicates there is an option to reduce its allocation the policy aligns with this, such a resource partition may be considered for reduction. Otherwise, filter it from the list of resource partitions.
3. For the filtered list of resource partitions, calculate the relative reduction required per partition in order to meet the overall target.
4. If there is a resource partition which cannot meet its target (e.g. based on PM data), reduce its target to what it can achieve and redistribute the difference over the other partitions.
5. If the overall target cannot be achieved due to the change in spectrum sharing reconfiguration in a cell, raise an alarm.

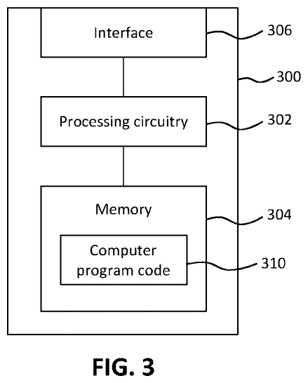

FIG. 3 is a schematic of an example of an apparatus 300 for allocating resources in a cell, wherein a first proportion of resources in the cell are allocated to a first radio access technology (RAT) and a second proportion of the resources in the cell are allocated to a second RAT different to the first RAT, and the cell supports resource partitioning of resources of the first RAT for one or more groups of one or more networks, network slices or User Equipments (UEs). The apparatus 300 comprises processing circuitry 302 (e.g. one or more processors) and a memory 304 in communication with the processing circuitry 302. The memory 304 contains instructions, such as computer program code 310, executable by the processing circuitry 302. The apparatus 300 also comprises an interface 306 in communication with the processing circuitry 302. Although the interface 306, processing circuitry 302 and memory 304 are shown connected in series, these may alternatively be interconnected in any other way, for example via a bus.

In one embodiment, the memory 304 contains instructions executable by the processing circuitry 302 such that the apparatus 300 is operable/configured to determine, for individual groups, one or more respective proportions of the resources for the group based on the resource partitioning; determine, for individual groups, one or more adjusted proportions of the resources based on the determined one or more respective proportions of the resources for the group and the first proportion of the resources of the cell allocated to the first RAT; and allocate the resources of the cell based on the one or more adjusted proportions of the resources of the cell for individual groups. In some examples, the apparatus 300 is operable/configured to carry out the method 200 described above with reference to FIG. 2.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method of allocating resources in a cell, wherein a first proportion of resources in the cell are allocated to a first radio access technology (RAT) and a second proportion of the resources in the cell are allocated to a second RAT different to the first RAT, and the cell supports resource partitioning of resources of the first RAT for one or more groups of one or more networks, network slices or User Equipments (UEs), the method comprising:
determining, for individual groups, one or more respective proportions of the resources for the group based on the resource partitioning;
determining, for individual groups, one or more adjusted proportions of the resources based on the determined one or more respective proportions of the resources for the group and the first proportion of the resources of the cell allocated to the first RAT; and
allocating the resources of the cell based on the one or more adjusted proportions of the resources of the cell for individual groups.

2. The method of claim 1, wherein determining, for individual groups, the one or more respective proportions of the resources for the group based on the resource partitioning comprises, for individual groups:
determining a proportion of the resources to be dedicated to the group by the resource partitioning;
determining a proportion of the resources to be prioritized for the group by the resource partitioning; and/or
determining a proportion of the resources to be shared by the group by the resource partitioning.

3. The method of claim 2, wherein determining, for individual groups, one or more adjusted proportions of the resources comprises:
determining an adjusted proportion of the resources of the cell to be dedicated to the group based on the proportion of the resources to be dedicated to the group and the first proportion of the resources of the cell allocated to the first RAT;
determining an adjusted proportion of the resources of the cell to be prioritized for the group based on the proportion of the resources to be prioritized for the group and the first proportion of the resources of the cell allocated to the first RAT; and/or
determining an adjusted proportion of the resources of the cell to be shared by the group based on the proportion of the resources to be shared by the group and the first proportion of the resources of the cell allocated to the first RAT.

4. The method of claim 3, wherein allocating the resources of the cell based on the one or more adjusted proportions of the resources of the cell for individual groups comprises allocating the resources of the cell based on:
the adjusted proportion of the resources of the cell to be dedicated to the group;
the adjusted proportion of the resources of the cell to be prioritized for the group; and/or
adjusted proportion of the resources of the cell to be shared by the group.

5. The method of claim 3, wherein determining, for individual groups, one or more adjusted proportions of the resources comprises, for individual groups, determining one or more adjusted proportions of the resources for the group such that a total of at least the adjusted proportion of the resources to be dedicated to the group and the adjusted proportion of the resources to be prioritized for the group does not exceed the first proportion of the resources in the cell.

6. The method of claim 1, wherein determining, for individual groups, one or more adjusted proportions of the resources comprises, for individual groups, determining one or more adjusted proportions of the resources for the group such that each adjusted proportion does not exceed the first proportion of the resources in the cell.

7. The method of claim 1, wherein allocating the resources of the cell based on the one or more adjusted proportions of the resources of the cell for individual groups comprises allocating one or more subcarriers, frequencies, time slots, transmission time intervals (TTIs), resource elements (REs), resource blocks (RBs) and/or frames based on the one or more adjusted proportions of the resources of the cell for individual groups.

8. The method of claim 1, wherein the method is performed in response to a change of the first proportion of the resources in the cell allocated to the first RAT and/or a change of the second proportion of the resources in the cell allocated to the second RAT.

9. The method of claim 1, wherein the first RAT comprises New Radio (NR), and/or the second RAT comprises Long Term Evolution (LTE).

10. The method of claim 1, wherein the one or more groups of one or more networks, network slices or User Equipments (UEs) comprise one or more groups of Public Land Mobile Network Identifiers (PLMN IDs) and/or Single-Network Slice Selection Assistance Information (S-NSSAIs).

11. The method of claim 1, wherein the first proportion of resources in the cell allocated to the first RAT comprises a first uplink proportion of uplink resources and a first downlink proportion of downlink resources.

12. The method of claim 11, wherein determining, for individual groups, one or more adjusted proportions of the resources of the cell comprises:
determining one or more adjusted proportions of the uplink resources of the cell based on the one or more proportions of the resources for the group and the first uplink proportion of the uplink resources of the cell allocated to the first RAT; and/or
determining one or more adjusted proportions of the downlink resources of the cell based on the one or more proportions of the resources for the group and the first downlink proportion of the downlink resources of the cell allocated to the first RAT.

13. The method of claim 12, wherein allocating the resources of the cell comprises allocating the uplink resources of the cell based on the one or more adjusted proportions of the uplink resources of the cell for individual groups, and/or allocating the downlink resources of the cell based on the one or more adjusted proportions of the downlink resources of the cell for individual groups.

14. The method of claim 11, wherein the second proportion of resources in the cell allocated to the second RAT comprises a second uplink proportion of uplink resources and a second downlink proportion of downlink resources.

15. The method of claim 1, wherein at least allocating the resources of the cell based on the one or more adjusted proportions of the resources of the cell for individual groups is performed by a resource scheduler.

16-17. (canceled)

18. A computer program product comprising non transitory computer readable media having stored thereon a computer program comprising instructions which, when executed on at least one processor, cause the at least one processor to carry out a method according to claim 1.

19. Apparatus for allocating resources in a cell, wherein a first proportion of resources in the cell are allocated to a first radio access technology (RAT) and a second proportion of the resources in the cell are allocated to a second RAT different to the first RAT, and the cell supports resource partitioning of resources of the first RAT for one or more groups of one or more networks, network slices or User Equipments (UEs), the apparatus comprising a processor and a memory, the memory containing instructions executable by the processor such that the apparatus is operable to:
determine, for individual groups, one or more respective proportions of the resources for the group based on the resource partitioning;
determine, for individual groups, one or more adjusted proportions of the resources based on the determined one or more respective proportions of the resources for the group and the first proportion of the resources of the cell allocated to the first RAT; and
allocate the resources of the cell based on the one or more adjusted proportions of the resources of the cell for individual groups.

20. The apparatus of claim 19, wherein the memory contains instructions executable by the processor such that the apparatus is operable to determine, for individual groups, the one or more respective proportions of the resources for the group based on the resource partitioning by, for individual groups:
determining a proportion of the resources to be dedicated to the group by the resource partitioning;
determining a proportion of the resources to be prioritized for the group by the resource partitioning; and and/or
determining a proportion of the resources to be shared by the group by the resource partitioning.

21. The apparatus of claim 20, wherein the memory contains instructions executable by the processor such that the apparatus is operable to determine, for individual groups, one or more adjusted proportions of the resources by:
determining an adjusted proportion of the resources of the cell to be dedicated to the group based on the proportion of the resources to be dedicated to the group and the first proportion of the resources of the cell allocated to the first RAT;
determining an adjusted proportion of the resources of the cell to be prioritized for the group based on the proportion of the resources to be prioritized for the group and the first proportion of the resources of the cell allocated to the first RAT; and/or
determining an adjusted proportion of the resources of the cell to be shared by the group based on the proportion of the resources to be shared by the group and the first proportion of the resources of the cell allocated to the first RAT.

22. The apparatus of claim 21, wherein the memory contains instructions executable by the processor such that the apparatus is operable to allocate the resources of the cell based on the one or more adjusted proportions of the resources of the cell for individual groups by allocating the resources of the cell based on:
the adjusted proportion of the resources of the cell to be dedicated to the group;
the adjusted proportion of the resources of the cell to be prioritized for the group; and/or
adjusted proportion of the resources of the cell to be shared by the group.

23-35. (canceled)
